(19) United States
(12) Patent Application Publication
(10) Pub. No.: US 2025/0296368 A1
(43) Pub. Date: Sep. 25, 2025

(54) IMAGE FORMING APPARATUS CAPABLE OF SUPPRESSING GENERATION OF CURLS IN SHEETS, AND IMAGE FORMING METHOD

(71) Applicant: KYOCERA Document Solutions Inc., Osaka (JP)

(72) Inventors: Takeshi Watanabe, Osaka (JP); Nobuyuki Hayashi, Osaka (JP); Kenichiro Kawasaki, Osaka (JP); Akihisa Mori, Osaka (JP); Yutaka Betto, Osaka (JP)

(21) Appl. No.: 19/078,699

(22) Filed: Mar. 13, 2025

(30) Foreign Application Priority Data
Mar. 22, 2024 (JP) 2024-046257

(51) Int. Cl. B41J 13/00; B41J 3/60; B41J 11/00

(52) U.S. Cl. CPC B41J 13/0045; B41J 3/60; B41J 11/0005

(57) ABSTRACT

An image forming apparatus includes an acquisition processing portion and a stop processing portion. The acquisition processing portion acquires, when duplex image forming processing is executed, adherence amount information related to an adherence amount of ink by image formation for each of a plurality of specific areas preset in an image forming area on a first surface of a sheet. The stop processing portion temporarily stops, based on a stop time set based on a plurality of pieces of the adherence amount information, conveyance of the sheet after the image formation on the first surface of the sheet and before the image formation on the second surface of the sheet during the execution of the duplex image forming processing.

### INCORPORATION BY REFERENCE

This application is based upon and claims the benefit of priority from the corresponding Japanese Patent Application No. 2024-046257 filed on Mar. 22, 2024, the entire contents of which are incorporated herein by reference.

### BACKGROUND

The present disclosure relates to an image forming apparatus and an image forming method.

An image forming apparatus that uses an inkjet method includes an ejection portion such as a recording head which ejects ink toward a conveyed sheet. In this type of image forming apparatus, during execution of duplex image forming processing for forming images on both surface of the sheet, a curl may be generated in the sheet due to the ink that has adhered onto a front surface of the sheet after image formation is performed on the front surface and before image formation is performed on a back surface, and this may cause a problem such as the sheet coming into contact with the ejection portion during the image formation on the back surface. In contrast, there is known an image forming apparatus in which conveyance of the sheet is temporarily stopped for a stop time that is based on an amount of the ink that adheres onto the front surface of the sheet, after image formation is performed on the front surface and before image formation is performed on the back surface. There is also known, as the related art, an image forming apparatus which sets the stop time based only on the amount of the ink that adheres onto an end portion of the front surface of the sheet that is apt to be curled for suppressing unnecessary prolongation of the stop time.

### SUMMARY

An image forming apparatus according to an aspect of the present disclosure includes an ejection portion, an acquisition processing portion, a setting processing portion, and a stop processing portion. The ejection portion ejects ink toward a conveyed sheet. The acquisition processing portion acquires, when duplex image forming processing for forming images on a first surface and second surface of the sheet using the ejection portion is executed, adherence amount information related to an adherence amount of the ink by the image formation for each of a plurality of specific areas preset in an image forming area on the first surface of the sheet. The setting processing portion sets a stop time during which conveyance of the sheet is stopped, based on a plurality of pieces of the adherence amount information acquired by the acquisition processing portion. The stop processing portion temporarily stops, based on the stop time set by the setting processing portion, the conveyance of the sheet after the image formation on the first surface of the sheet and before the image formation on the second surface of the sheet during the execution of the duplex image forming processing. The plurality of specific areas include a center portion area that is set at a center portion of the image forming area and an end portion area that is set at an end portion of the image forming area.

An image forming method according to another aspect of the present disclosure is executed in an image forming apparatus including an ejection portion which ejects ink toward a conveyed sheet and includes an acquisition step, a setting step, and a stop step. The acquisition step includes acquiring, when duplex image forming processing for forming images on a first surface and second surface of the sheet using the ejection portion is executed, adherence amount information related to an adherence amount of the ink by the image formation for each of a plurality of specific areas preset in an image forming area on the first surface of the sheet. The setting step includes setting a stop time during which conveyance of the sheet is stopped, based on a plurality of pieces of the adherence amount information acquired in the acquisition step. The stop step includes temporarily stopping, based on the stop time set in the setting step, the conveyance of the sheet after the image formation on the first surface of the sheet and before the image formation on the second surface of the sheet during the execution of the duplex image forming processing. The plurality of specific areas include a center portion area that is set at a center portion of the image forming area and an end portion area that is set at an end portion of the image forming area.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram showing a configuration of an image forming apparatus according to an embodiment of the present disclosure;

FIG. 2 is a block diagram showing a system configuration of the image forming apparatus according to the embodiment of the present disclosure;

FIG. 3 is a diagram showing a configuration of a head portion of the image forming apparatus according to the embodiment of the present disclosure;

FIG. 4 is a diagram showing a configuration in a periphery of a nozzle in the image forming apparatus according to the embodiment of the present disclosure;

FIG. 5 is a diagram showing an example of a plurality of specific areas set on a front surface of a sheet in the image forming apparatus according to the embodiment of the present disclosure;

FIG. 6 is a diagram showing an example of first table data that is stored in a storage portion of the image forming apparatus according to the embodiment of the present disclosure;

FIG. 7 is a diagram showing an example of second table data that is stored in the storage portion of the image forming apparatus according to the embodiment of the present disclosure;

FIG. 8 is a diagram showing an example of third table data that is stored in the storage portion of the image forming apparatus according to the embodiment of the present disclosure; and

FIG. 9 is a flowchart showing an example of conveyance control processing executed in the image forming apparatus according to the embodiment of the present disclosure.

### DETAILED DESCRIPTION

Hereinafter, an embodiment of the present disclosure will be described with reference to the attached drawings. It is noted that the following embodiment is an example of embodying the present disclosure and does not limit the technical scope of the present disclosure.

### [Configuration of Image Forming Apparatus 100]

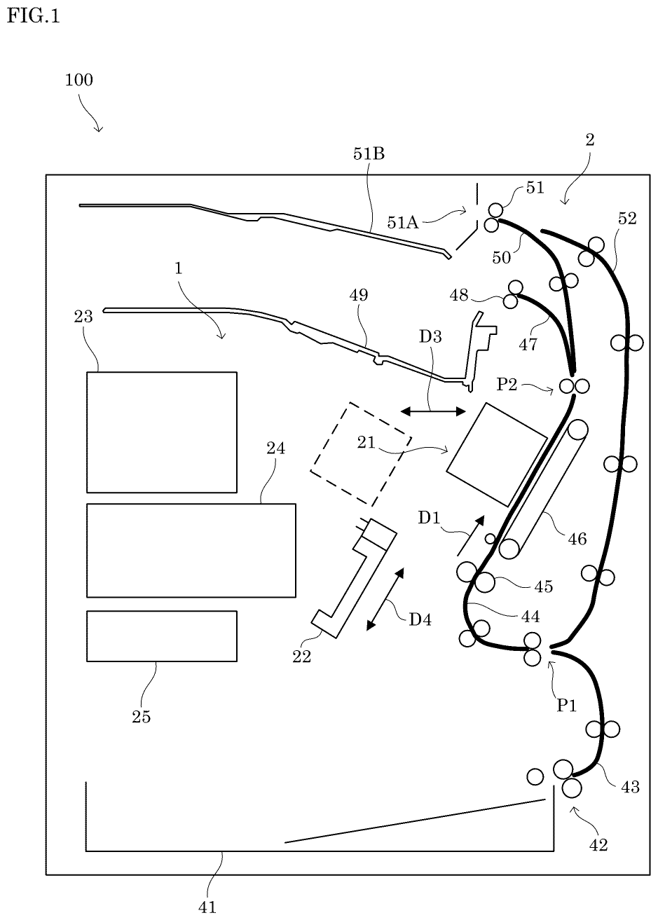

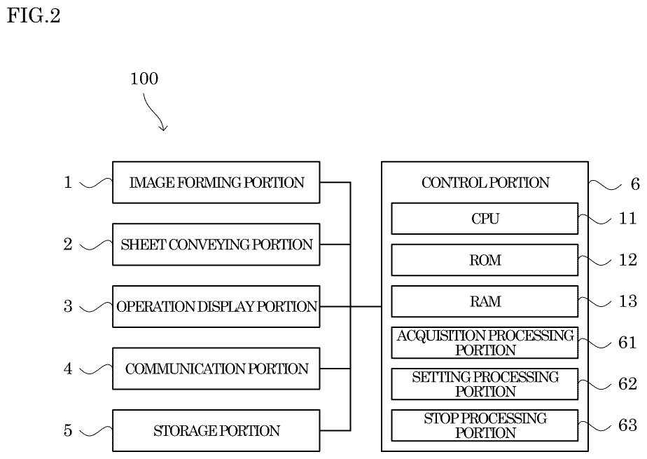

First, a configuration of an image forming apparatus 100 according to an embodiment of the present disclosure will be described with reference to FIG. 1 and FIG. 2. Herein, FIG. 1 is a cross-sectional view showing the configuration of the image forming apparatus 100.

The image forming apparatus 100 is a printer which forms an image on a sheet by an inkjet method. It is noted that the present disclosure can be applied to a facsimile apparatus, a copying machine, a multifunction peripheral, and the like that form images on sheets by the inkjet method.

As shown in FIG. 1 and FIG. 2, the image forming apparatus 100 includes an image forming portion 1, a sheet conveying portion 2, an operation display portion 3, a communication portion 4, a storage portion 5, and a control portion 6.

The image forming portion 1 forms an image on a sheet by the inkjet method based on image data input from an external information processing apparatus such as a personal computer.

The sheet conveying portion 2 conveys sheets on which images are to be formed by the image forming portion 1.

The operation display portion 3 is a user interface of the image forming apparatus 100. The operation display portion 3 includes a display portion and an operation portion. The display portion displays various types of information in response to control instructions from the control portion 6. For example, the display portion is a flat panel display such as a liquid crystal display. The operation portion is used to input various types of information to the control portion 6 in accordance with user operations. For example, the operation portion includes an operation key and a touch panel.

The communication portion 4 is a communication interface which executes wired or wireless data communication with the external information processing apparatus.

The storage portion 5 is a nonvolatile storage device. For example, the storage portion 5 is a nonvolatile memory such as a flash memory.

The control portion 6 collectively controls the image forming apparatus 100. As shown in FIG. 2, the control portion 6 includes a CPU 11, a ROM 12, and a RAM 13. The CPU 11 is a processor that executes various types of arithmetic processing. The ROM 12 is a nonvolatile storage device in which information such as control programs for causing the CPU 11 to execute various types of processing is stored in advance. The RAM 13 is a volatile or nonvolatile storage device that is used as a temporary storage memory (working area) for the various type of processing to be executed by the CPU 11. In the control portion 6, the CPU 11 executes the various control programs stored in advance in the ROM 12. Thus, the control portion 6 collectively controls the image forming apparatus 100. It is noted that the control portion 6 may be constituted of an electronic circuit such as an integrated circuit (ASIC). Alternatively, the control portion 6 may be a control portion provided separate from a main control portion that collectively controls the image forming apparatus 100.

### [Configurations of Image Forming Portion 1 and Sheet Conveying Portion 2]

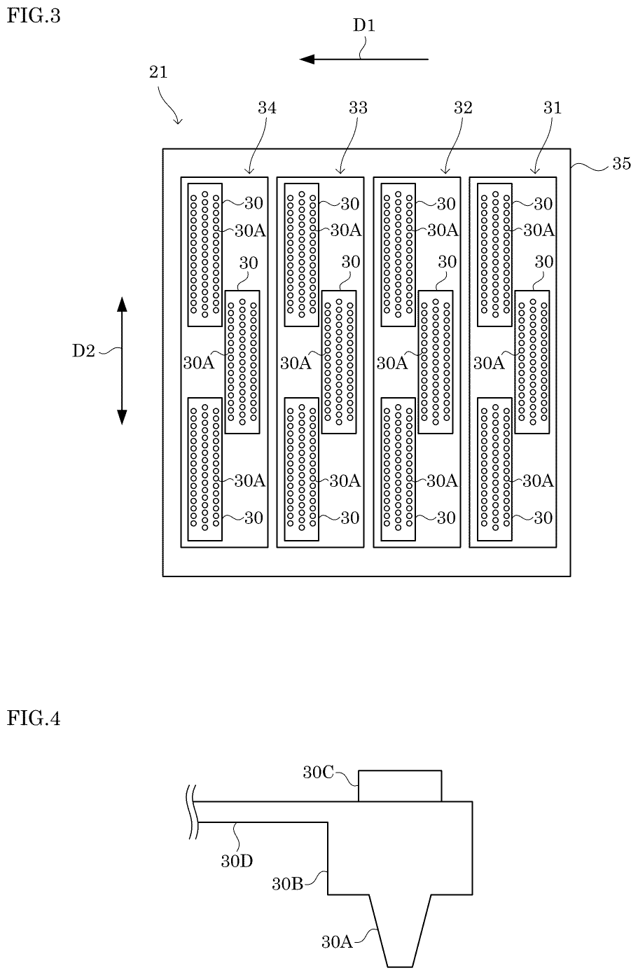

Next, configurations of the image forming portion 1 and the sheet conveying portion 2 will be described with reference to FIG. 1, FIG. 3, and FIG. 4. Herein, FIG. 3 is a diagram in which a head portion 21 is seen from a side of an ink discharge direction by the head portion 21. Further, FIG. 4 is a cross-sectional view showing a configuration in a periphery of a nozzle 30A.

As shown in FIG. 1, the image forming portion 1 includes the head portion 21, a cap portion 22, an ink storage portion 23, an ink supply flow path portion 24, and a waste ink storage portion 25.

The head portion 21 ejects ink toward a sheet conveyed by the sheet conveying portion 2. The head portion 21 is an example of an ejection portion according to the present disclosure.

As shown in FIG. 3, the head portion 21 includes line heads 31 to 34 and a head frame 35.

As shown in FIG. 3, each of the line heads 31 to 34 is elongated in a width direction D2 orthogonal to a conveying direction D1 of the sheet by the sheet conveying portion 2. Specifically, each of the line heads 31 to 34 has, in the width direction D2, a length corresponding to a width of a sheet of a maximum size out of the sheets that can be stored in a sheet feed cassette 41. The line heads 31 to 34 are provided so as to be aligned at regular intervals along the conveying direction D1.

As shown in FIG. 3, each of the line heads 31 to 34 includes a plurality of recording heads 30. Each of the recording heads 30 ejects ink droplets toward the sheet conveyed by the sheet conveying portion 2. Each of the recording heads 30 provided in the line head 31 ejects black ink droplets. Each of the recording heads 30 provided in the line head 32 ejects cyan ink droplets. Each of the recording heads 30 provided in the line head 33 ejects magenta ink droplets. Each of the recording heads 30 provided in the line head 34 ejects yellow ink droplets.

Each of the recording heads 30 includes a plurality of nozzles 30A (see FIG. 3) that eject ink droplets. The nozzles 30A are provided on an opposing surface of the recording head 30 that opposes the sheet conveyed by the sheet conveying portion 2.

Further, each of the recording heads 30 includes pressurization chambers 30B (see FIG. 4), piezoelectric elements 30C (see FIG. 4), and individual flow paths 30D (see FIG. 4) that respectively correspond to the nozzles 30A. The pressurization chamber 30B is in communication with the nozzle 30A and stores ink. The piezoelectric element 30C causes the ink droplets to be ejected from the nozzle 30A in accordance with an input of a predetermined driving signal. Specifically, the piezoelectric element 30C varies a pressure of the pressurization chamber 30B in accordance with an input of the driving signal, to thus cause the ink droplets to be ejected from the nozzle 30A. The individual flow path 30D is an ink flow path provided between the pressurization chamber 30B and a common flow path (not shown) common to the plurality of nozzles 30A. The plurality of individual flow paths 30D respectively corresponding to the plurality of nozzles 30A are connected to the common flow path. The common flow path is connected to the ink storage portion 23 (see FIG. 1) via the ink supply flow path portion 24 (see FIG. 1).

In the image forming apparatus 100, any one of a first driving signal, a second driving signal, a third driving signal, a fourth driving signal, and a fifth driving signal is input to the piezoelectric element 30C. In response to an input of the first driving signal, the piezoelectric element 30C ejects extra-small-sized ink droplets. Further, in response to an input of the second driving signal, the piezoelectric element 30C ejects small-sized ink droplets. Furthermore, in response to an input of the third driving signal, the piezoelectric element 30C ejects medium-sized ink droplets. Furthermore, in response to an input of the fourth driving signal, the piezoelectric element 30C ejects large-sized ink droplets. Moreover, in response to an input of the fifth driving signal, the piezoelectric element 30C ejects extra-large-sized ink droplets.

As shown in FIG. 3, the line head 31 includes three recording heads 30 that are arranged in a staggered pattern along the width direction D2. Similar to the line head 31, each of the other line heads 32 to 34 also includes three recording heads 30 that are arranged in a staggered pattern along the width direction D2.

The head frame 35 supports the line heads 31 to 34.

The head portion 21 is provided to be movable between an image forming position at which an image can be formed on a sheet conveyed by the sheet conveying portion 2 and a first evacuation position evacuated from the image forming position. Specifically, the head frame 35 is supported by a housing of the image forming apparatus 100 while being movable along a movement direction D3 shown in FIG. 1. It is noted that in FIG. 1, the head portion 21 arranged at the image forming position is indicated by a solid line. Also in FIG. 1, the head portion 21 arranged at the first evacuation position is indicated by a broken line.

It is noted that the number of line heads to be provided in the head portion 21 does not need to be limited to four. Further, the number of recording heads 30 to be provided in each of the line heads 31 to 34 does not need to be limited to three.

The cap portion 22 caps each of the nozzles 30A of the head portion 21 arranged at the first evacuation position.

The cap portion 22 is provided to be movable between a cap position at which each of the nozzles 30A of the head portion 21 arranged at the first evacuation position can be capped and a second evacuation position evacuated from the cap position. Specifically, the cap portion 22 is supported by the housing of the image forming apparatus 100 while being movable along a movement direction D4 shown in FIG. 1. It is noted that in FIG. 1, the cap portion 22 arranged at the second evacuation position is indicated by a solid line.

When the head portion 21 is arranged at the first evacuation position, the cap portion 22 is moved along the movement direction D4. The cap portion 22 includes a brush-type cleaning portion which cleans a nozzle surface of the recording head 30 on which the nozzles 30A are formed while moving between the first evacuation position and the cap position.

In the image forming apparatus 100, purge processing for causing ink to be discharged from each of the nozzles 30A is executed in a state where each of the nozzles 30A of the head portion 21 arranged at the first evacuation position is capped by the cap portion 22. The ink discharged from each of the nozzles 30A by the purge processing is stored in the waste ink storage portion 25 via a waste ink flow path (not shown) connected to the cap portion 22.

The ink storage portion 23 stores ink of the respective colors that is to be supplied to the head portion 21.

The ink supply flow path portion 24 forms ink flow paths for the ink of the respective colors, that connect the ink storage portion 23 and the head portion 21.

The waste ink storage portion 25 stores the ink discharged from each of the nozzles 30A by the purge processing.

As shown in FIG. 1, the sheet conveying portion 2 includes the sheet feed cassette 41, a sheet feed portion 42, a sheet feed path 43, a conveying path 44, a registration roller pair 45, a conveying belt 46, a sheet discharge path 47, a sheet discharge roller pair 48, a sheet discharge tray 49, a first inversion conveying path 50, an inversion conveying roller pair 51, and a second inversion conveying path 52. It is noted that in FIG. 1, the sheet feed path 43, the conveying path 44, the sheet discharge path 47, the first inversion conveying path 50, and the second inversion conveying path 52 are indicated by bold solid lines.

The sheet feed cassette 41 stores sheets on which images are to be formed by the image forming portion 1. For example, sheets such as plain paper for inkjet and matte paper for inkjet are stored in the sheet feed cassette 41. The plain paper for inkjet and the matte paper for inkjet are sheets having characteristics suited for image formation by the inkjet method.

The sheet feed portion 42 supplies the sheets stored in the sheet feed cassette 41 one by one to the sheet feed path 43.

The sheet feed path 43 is a sheet movement path that is provided from the sheet feed portion 42 to a first position P1 (see FIG. 1) inside the housing of the image forming apparatus 100. The sheet feed path 43 is connected to the conveying path 44 at the first position P1. On the sheet feed path 43, the sheet is conveyed toward the conveying path 44.

The conveying path 44 is a sheet movement path that is provided from the first position P1 to a second position P2 (see FIG. 1) inside the housing of the image forming apparatus 100. The conveying path 44 is connected to the sheet discharge path 47 at the second position P2. On the conveying path 44, the sheet is conveyed in the conveying direction D1 shown in FIG. 1.

The conveying belt 46 forms a partial section of the conveying path 44. Inside the housing of the image forming apparatus 100, the conveying belt 46 is provided at a position that opposes the head portion 21 arranged at the image forming position. The conveying belt 46 is stretched across a pair of tension rollers. The sheet to which charges have been applied by a charge application roller electrostatically sticks to an outer circumferential surface of the conveying belt 46. The conveying belt 46 conveys the sheet electrostatically stuck to the outer circumferential surface thereof. In addition, the conveying belt 46 supports the sheet onto which ink droplets are ejected by the head portion 21.

The registration roller pair 45 is provided more on the upstream side of the conveying direction D1 than the conveying belt 46 on the conveying path 44. The registration roller pair 45 is used to correct a skew of the sheet.

The sheet discharge path 47 is a sheet movement path that is provided from the second position P2 to the sheet discharge roller pair 48. On the sheet discharge path 47, the sheet is conveyed toward the sheet discharge roller pair 48.

The sheet discharge roller pair 48 discharges the sheet onto the sheet discharge tray 49.

The sheet discharged by the sheet discharge roller pair 48 is stacked on the sheet discharge tray 49.

The first inversion conveying path 50 is a sheet movement path that is provided from the second position P2 to a sheet discharge outlet 51A (see FIG. 1) formed at an upper portion of the housing of the image forming apparatus 100. On the first inversion conveying path 50, the sheet is conveyed toward the sheet discharge outlet 51A.

The inversion conveying roller pair 51 is provided at the sheet discharge outlet 51A. The inversion conveying roller pair 51 switches back the sheet to supply the sheet to the second inversion conveying path 52. Specifically, the inversion conveying roller pair 51 causes the sheet to protrude toward the outside of the housing of the image forming apparatus 100 from the sheet discharge outlet 51A until nipping an end portion of the sheet on the upstream side of the conveying direction D1 (rear end). Then, the inversion conveying roller pair 51 rotates backwards at a timing at which the rear end of the sheet is nipped, to switch back the sheet. It is noted that a sheet support tray 51B (see FIG. 1) which supports the sheet that protrudes form the sheet discharge outlet 51A is formed on an upper surface of the housing of the image forming apparatus 100.

The second inversion conveying path 52 is a sheet movement path that is provided from the inversion conveying roller pair 51 to the first position P1 (see FIG. 1). On the second inversion conveying path 52, the sheet is conveyed toward the first position P1.

In the image forming apparatus 100, duplex image forming processing for forming images on a front surface (an example of a first surface according to the present disclosure) and back surface (an example of a second surface according to the present disclosure) of a sheet conveyed by the sheet conveying portion 2 using the head portion 21 is executed.

Incidentally, in a conventional image forming apparatus, during execution of the duplex image forming processing, a curl may be generated in a sheet due to ink that has adhered onto a front surface of the sheet after image formation is performed on the front surface and before image formation is performed on a back surface, and this may cause a problem such as the sheet coming into contact with the head portion 21 during the image formation on the back surface. In contrast, there is known an image forming apparatus in which conveyance of the sheet is temporarily stopped for a stop time that is based on an amount of the ink that adheres onto the front surface of the sheet, after image formation is performed on the front surface and before image formation is performed on the back surface. There is also known, as the related art, an image forming apparatus which sets the stop time based only on the amount of the ink that adheres onto an end portion of the front surface of the sheet that is apt to be curled for suppressing unnecessary prolongation of the stop time.

However, the sheet curls also when a large amount of ink adheres to an area including a center portion of the front surface of the sheet. Therefore, the image forming apparatus according to the related art described above may not be able to suppress generation of curls in the sheets.

In contrast, in the image forming apparatus 100 according to the embodiment of the present disclosure, it is possible to suppress generation of curls in the sheets as well as suppress unnecessary prolongation of the stop time as will be described below.

### [Configuration of Control Portion 6]

Next, a configuration of the control portion 6 will be described with reference to FIG. 2.

As shown in FIG. 2, the control portion 6 includes an acquisition processing portion 61, a setting processing portion 62, and a stop processing portion 63.

Specifically, a conveyance control program for causing the CPU 11 to function as the respective processing portions described above is stored in advance in the ROM 12 of the control portion 6. Then, the CPU 11 executes the conveyance control program stored in the ROM 12 to thus function as the respective processing portions described above.

It is noted that the conveyance control program may be recorded onto a computer-readable recording medium such as a CD, a DVD, and a flash memory so as to be read from the recording medium to be stored in the storage portion 5. Further, some or all of the processing portions included in the control portion 6 may be constituted of an electronic circuit. Alternatively, the conveyance control program may be a program for causing a plurality of processors to function as the respective processing portions included in the control portion 6.

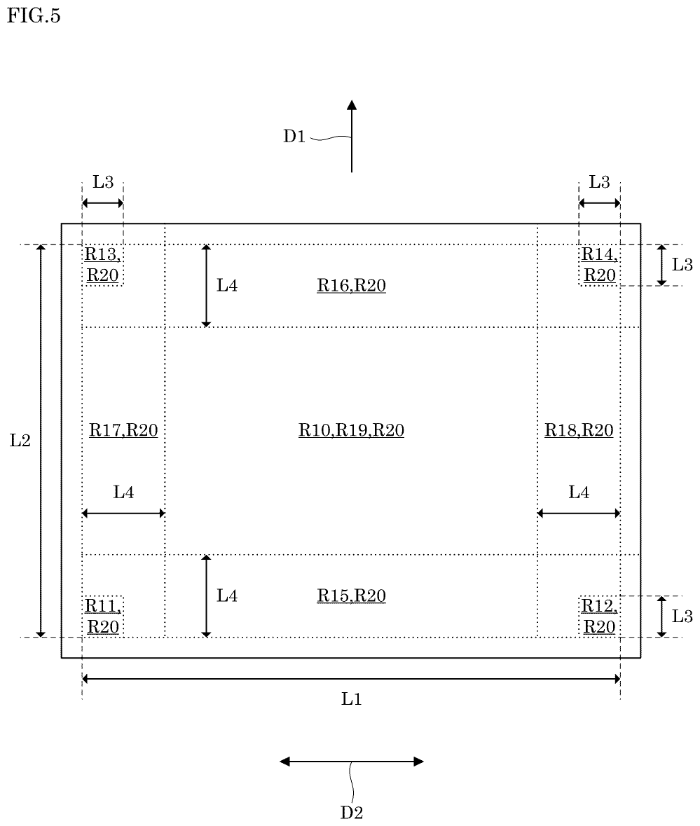

The acquisition processing portion 61 acquires, when the duplex image forming processing is executed, adherence amount information related to an adherence amount of the ink by the image formation for each of a plurality of specific areas R20 (R11 to R19) preset in an image forming area R10 (see FIG. 5) on the front surface of the sheet.

FIG. 5 shows an example of the image forming area R10 (see FIG. 5) set on the front surface of the sheet and the plurality of specific areas R20 (R11 to R19) set in the image forming area R10. It is noted that in FIG. 5, the image forming area R10 and the plurality of specific areas R20 are each indicated by dotted lines. The image forming area R10 is an area in which a size thereof in the width direction D2 is L1 and a size thereof in the conveying direction D1 is L2. The specific areas R11 to R14 are each an area in which a size thereof in the width direction D2 is L3 and a size thereof in the conveying direction D1 is L3. The specific areas R15 and R16 are each an area in which a size thereof in the width direction D2 is L1 and a size thereof in the conveying direction D1 is L4. The specific areas R17 and R18 are each an area in which a size thereof in the width direction D2 is L4 and a size thereof in the conveying direction D1 is L2. The specific area R19 is an area in which a size thereof in the width direction D2 is L1 and a size thereof in the conveying direction D1 is L2. In other words, the specific area R19 is an entire area of the image forming area R10.

It is noted that an area outside the image forming area R10 in the sheet is a marginal area. A size of the marginal area may be set arbitrarily. Alternatively, the image forming area R10 may be an entire area on the front surface of the sheet.

As shown in FIG. 5, the specific area R19 is set at a center portion of the image forming area R10. The specific area R19 is an example of a center portion area according to the present disclosure. It is noted that the specific area R19 may alternatively be a partial area of the image forming area R10 that includes the center portion of the image forming area R10.

As shown in FIG. 5, the specific areas R11 and R12 are respectively set at corner portions of the image forming area R10 on the upstream side of the conveying direction D1. The specific areas R11 and R12 are each an example of a first area according to the present disclosure and also an example of an end portion area according to the present disclosure.

As shown in FIG. 5, the specific areas R13 and R14 are respectively set at corner portions of the image forming area R10 on the downstream side of the conveying direction D1. The specific areas R13 and R14 are each an example of a second area according to the present disclosure and also an example of the end portion area according to the present disclosure.

As shown in FIG. 5, the specific areas R15 and R16 are respectively set at end portions of the image forming area R10 along the conveying direction D1. Further, as shown in FIG. 5, the specific areas R17 and R18 are respectively set at end portions of the image forming area R10 in the width direction D2. The specific areas R15 to R18 are each an example of the end portion area according to the present disclosure.

For example, the adherence amount information is information indicating a coverage rate in each of the specific areas R20.

In the image forming apparatus 100, the coverage rate is a ratio of the number of dots of a predetermined specific size that are formed in the specific area R20 to the number of dots that can be formed in the specific area R20. For example, the dots of the specific size are dots formed on a sheet by medium-sized ink droplets ejected from the nozzles 30A. In other words, when the medium-sized ink droplets are ejected onto all dot-formable areas included in the specific area R20, the coverage rate in the specific area R20 is 100 percent. Moreover, when large-sized ink droplets are ejected onto all the dot-formable areas included in the specific area R20, the coverage rate in the specific area R20 exceeds 100 percent.

For example, in the image forming apparatus 100, bitmap image data of an image to be formed is decomposed into four pieces of color component data respectively corresponding to the colors of black, cyan, magenta, and yellow. In addition, in the image forming apparatus 100, conversion processing is executed for converting, for each piece of the color component data, each piece of pixel data included in the color component data into either ejection pixel data used for ejecting ink droplets from the nozzles 30A corresponding to the pixel data or non-ejection pixel data used for not ejecting ink droplets from the nozzles 30A corresponding to the pixel data. The ejection pixel data includes first ejection pixel data used for generating the first driving signal, second ejection pixel data used for generating the second driving signal, third ejection pixel data used for generating the third driving signal, fourth ejection pixel data used for generating the fourth driving signal, and fifth ejection pixel data used for generating the fifth driving signal.

For example, the acquisition processing portion 61 calculates the coverage rate in the specific area R20 by the following procedures.

First, the acquisition processing portion 61 acquires the number of black ink droplets ejected onto the specific area R20 for each ink droplet size based on the color component data obtained after the conversion processing, that corresponds to black.

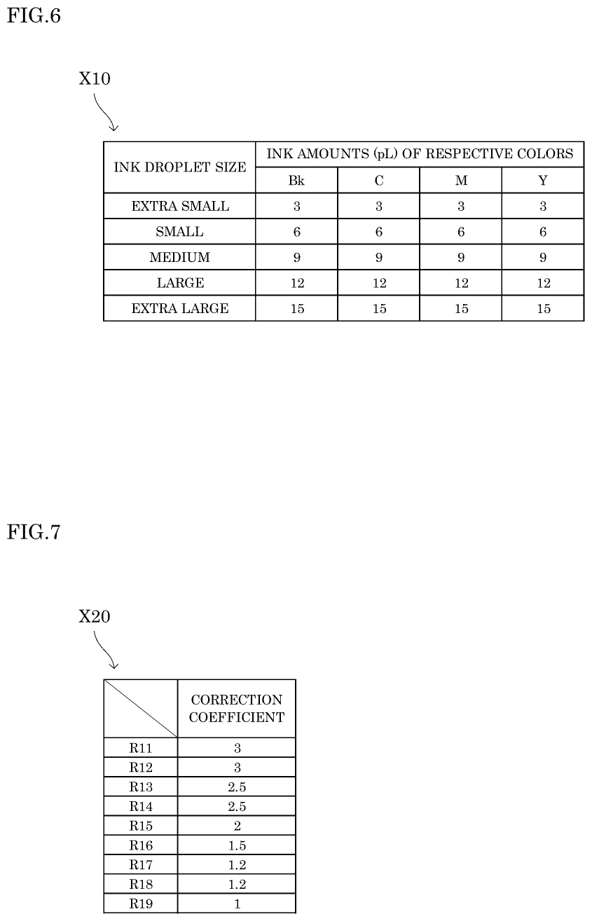

Next, the acquisition processing portion 61 calculates the coverage rate of black in the specific area R20 according to following Equation (1). It is noted that “B1” included in Equation (1) indicates the coverage rate of black in the specific area R20. Further, “a1” included in Equation (1) indicates the number of extra-small-sized black ink droplets ejected onto the specific area R20. Further, “a2” included in Equation (1) indicates the ink amount of the extra-small-sized black ink droplets. Further, “b1” included in Equation (1) indicates the number of small-sized black ink droplets ejected onto the specific area R20. Further, “b2” included in Equation (1) indicates the ink amount of the small-sized black ink droplets. Further, “c1” included in Equation (1) indicates the number of medium-sized black ink droplets ejected onto the specific area R20. Further, “c2” included in Equation (1) indicates the ink amount of the medium-sized black ink droplets. Further, “d1” included in Equation (1) indicates the number of large-sized black ink droplets ejected onto the specific area R20. Further, “d2” included in Equation (1) indicates the ink amount of the large-sized black ink droplets. Further, “e1” included in Equation (1) indicates the number of extra-large-sized black ink droplets ejected onto the specific area R20. Further, “e2” included in Equation (1) indicates the ink amount of the extra-large-sized black ink droplets. Further, “r1” included in Equation (1) indicates the number of dot-formable areas included in the specific area R20. It is noted that the ink amount of the black ink droplets of each size is acquired using first table data X10 (see FIG. 6) shown in FIG. 6. The first table data X10 is stored in advance in the storage portion 5.

$$B 1 = ( a 1 \times a 2 + b 1 \times b 2 + c 1 \times c 2 + d 1 \times d 2 + e 1 \times e 2 ) / ( r 1 \times c 2 ) \qquad ( 1 )$$

Next, the acquisition processing portion 61 calculates the coverage rate of each color other than black in the specific area R20 by procedures similar to those described above.

Then, the acquisition processing portion 61 calculates the coverage rate in the specific area R20 according to following Equation (2). It is noted that “V1” included in Equation (2) indicates the coverage rate in the specific area R20. Further, “C1” included in Equation (2) indicates the coverage rate of cyan in the specific area R20. Further, “M1” included in Equation (2) indicates the coverage rate of magenta in the specific area R20. Further, “Y1” included in Equation (2) indicates the coverage rate of yellow in the specific area R20.

$$V 1 = B 1 + C 1 + M 1 + Y 1 \qquad ( 2 )$$

The setting processing portion 62 sets a stop time during which the conveyance of the sheet is stopped, based on the plurality of pieces of adherence amount information acquired by the acquisition processing portion 61.

For example, the setting processing portion 62 sets the stop time based on a combination of the plurality of pieces of adherence amount information acquired by the acquisition processing portion 61, a type of the sheet, and a basis weight of the sheet. It is noted that the type and basis weight of the sheet used for the image formation in the duplex image forming processing are preset by a user before the execution of the duplex image forming processing.

For example, the setting processing portion 62 corrects each piece of the adherence amount information using a correction coefficient (see FIG. 7) preset for each specific area R20, and sets, as the stop time, a time acquired based on a maximum value out of the corrected adherence amount information.

For example, in the image forming apparatus 100, second table data X20 shown in FIG. 7 is stored in advance in the storage portion 5. The second table data X20 is data indicating a correspondence relationship between the specific area R20 and the correction coefficient.

As shown in FIG. 7, the correction coefficients respectively set for the specific areas R11 and R12 are the largest among the plurality of correction coefficients respectively corresponding to the plurality of specific areas R20. This is because, in the image forming area R10 on the front surface of the sheet, the corner portions on the upstream side of the conveying direction D1 are most likely to be curled.

Furthermore, as shown in FIG. 7, the correction coefficients respectively set for the specific areas R13 and R14 are second largest among the plurality of correction coefficients respectively corresponding to the plurality of specific areas R20. This is because, in the image forming area R10 on the front surface of the sheet, the corner portions on the downstream side of the conveying direction D1 are second-most likely to be curled.

Furthermore, as shown in FIG. 7, the correction coefficient set for the specific area R15 is third largest among the plurality of correction coefficients respectively corresponding to the plurality of specific areas R20. This is because, in the image forming area R10 on the front surface of the sheet, the end portion on the upstream side of the conveying direction D1 is third-most likely to be curled.

Furthermore, as shown in FIG. 7, the correction coefficient set for the specific area R16 is fourth largest among the plurality of correction coefficients respectively corresponding to the plurality of specific areas R20. This is because, in the image forming area R10 on the front surface of the sheet, the end portion on the downstream side of the conveying direction D1 is fourth-most likely to be curled.

Furthermore, as shown in FIG. 7, the correction coefficients respectively set for the specific areas R17 and R18 are fifth largest among the plurality of correction coefficients respectively corresponding to the plurality of specific areas R20. This is because, in the image forming area R10 on the front surface of the sheet, the end portions in the width direction D2 are fifth-most likely to be curled.

Furthermore, as shown in FIG. 7, the correction coefficient set for the specific area R19 is the smallest among the plurality of correction coefficients respectively corresponding to the plurality of specific areas R20. This is because, in the image forming area R10 on the front surface of the sheet, the area including the center portion is most unlikely to be curled.

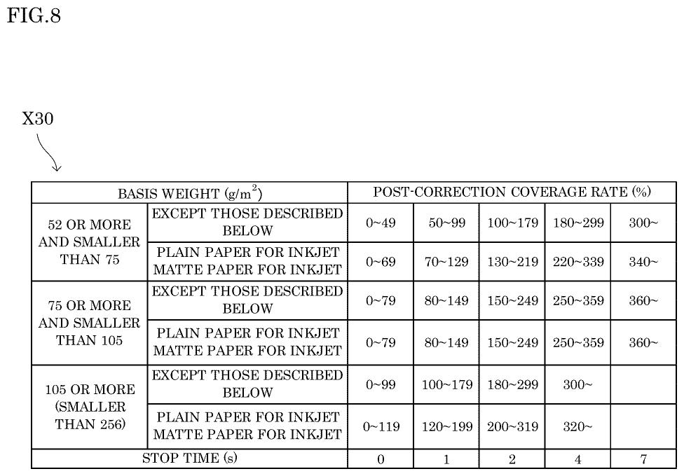

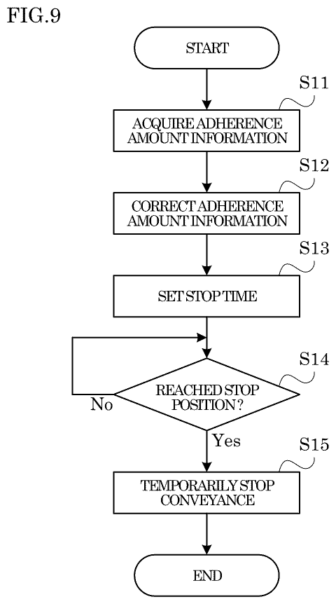

In addition, in the image forming apparatus 100, third table data X30 shown in FIG. 8 is stored in advance in the storage portion 5. The third table data X30 is data indicating a correspondence relationship between the combination of the corrected adherence amount information (the coverage rate), the basis weight of the sheet, and the type of the sheet and a time to be set as the stop time.

The setting processing portion 62 uses the second table data X20 to acquire the correction coefficient corresponding to the correction target specific area R20. Then, the setting processing portion 62 corrects the coverage rate by multiplying the coverage rate in the correction target specific area R20 by the acquired correction coefficient.

Further, the setting processing portion 62 uses the third table data X30 to acquire a time corresponding to a combination of a maximum value out of the plurality of pieces of corrected adherence amount information (the coverage rates), the basis weight of the sheet, and the type of the sheet. The setting processing portion 62 then sets the acquired time as the stop time. For example, when the basis weight of the sheet is “80”, the type of the sheet is “plain paper for inkjet”, and the maximum value out of the plurality of pieces of corrected adherence amount information (the coverage rates) is “120”, the setting processing portion 62 sets the stop time to 1 second.

It is noted that the third table data X30 may be provided for each specific area R20. In this case, the third table data X30 corresponding to the specific area R20 only needs to be created in accordance with the likelihood of generation of a curl in the specific area R20. In addition, the setting processing portion 62 only needs to acquire, for each specific area R20, a time (a candidate time for the stop time) corresponding to the specific area R20 using the third table data X30 corresponding to the specific area R20. Furthermore, the setting processing portion 62 only needs to set the longest time out of the times respectively acquired for the specific areas R20 as the stop time.

When the third table data X30 is provided for each of the specific areas R20, the setting processing portion 62 does not need to correct each piece of the adherence amount information. Further, when the third table data X30 is provided for each of the specific areas R20, the adherence amount information may be information indicating an adherence amount of ink in each of the specific areas R20.

In addition, the setting processing portion 62 may use a predetermined calculation equation instead of the third table data X30 to acquire the time corresponding to the combination of the maximum value out of the plurality of pieces of corrected adherence amount information (the coverage rates), the basis weight of the sheet, and the type of the sheet.

The stop processing portion 63 temporarily stops, based on the stop time set by the setting processing portion 62, the conveyance of the sheet after the image formation on the front surface of the sheet and before the image formation on the back surface of the sheet during the execution of the duplex image forming processing. In other words, the stop processing portion 63 stops the conveyance of the sheet, and resumes the conveyance of the sheet at a timing at which the stop time has elapsed since the stop of the conveyance.

For example, the stop processing portion 63 temporarily stops the conveyance of the sheet at a timing at which the rear end of the sheet is nipped by the inversion conveying roller pair 51 and a timing at which the rotation direction of the inversion conveying roller pair 51 is switched. Thus, since the conveyance of the sheet is temporarily stopped at a timing at which a large portion of the sheet protrudes toward the outside of the housing of the image forming apparatus 100, drying of the sheet can be facilitated.

### [Conveyance Control Processing]

Hereinafter, an image forming method according to the present disclosure will be described along with exemplary procedures of conveyance control processing executed by the control portion 6 in the image forming apparatus 100. Herein, Step S11, Step S12, . . . represent numbers of processing procedures (steps) executed by the control portion 6. It is noted that when the duplex image forming processing is executed, the conveyance control processing is executed together with the duplex image forming processing.

### <Step S11>

First, in Step S11, the control portion 6 acquires the adherence amount information for each of the specific areas R20 on the front surface of the sheet. Herein, the processing of Step S11 is an example of an acquisition step according to the present disclosure and is executed by the acquisition processing portion 61 of the control portion 6.

### <Step S12>

In Step S12, the control portion 6 corrects each piece of the adherence amount information acquired in Step S11 using the correction coefficient (see FIG. 7) preset for each of the specific areas R20.

### <Step S13>

In Step S13, the control portion 6 sets the stop time based on a combination of a maximum value out of the adherence amount information corrected by the processing of Step S12, the type of the sheet, and the basis weight of the sheet. Herein, the processing of Step S12 and Step S13 is an example of a setting step according to the present disclosure and is executed by the setting processing portion 62 of the control portion 6.

### <Step S14>

In Step S14, the control portion 6 determines whether or not the sheet has reached the arrangement position of the inversion conveying roller pair 51, which is the stop position.

Herein, when determining that the sheet has reached the stop position (Yes in Step S14), the control portion 6 shifts the processing to Step S15. On the other hand, when determining that the sheet has not reached the stop position (No in Step S14), the control portion 6 waits for the sheet to reach the stop position in Step S14.

### <Step S15>

In Step S15, the control portion 6 temporarily stops the conveyance of the sheet based on the stop time set by the processing of Step S13. Herein, the processing of Step S15 is an example of a stop step according to the present disclosure and is executed by the stop processing portion 63 of the control portion 6.

In this manner, in the image forming apparatus 100, when the duplex image forming processing is executed, the adherence amount information is acquired for each of the plurality of specific areas R20 including the specific area R19 set at the center portion of the image forming area R10 and the specific areas R11 to R18 set at the end portions of the image forming area R10. Then, the stop time is set based on the plurality of pieces of acquired adherence amount information. Thus, it is possible to suppress unnecessary prolongation of the stop time as compared to a configuration in which the stop time is set based only on the adherence amount information in the entire image forming area R10. In addition, it is possible to suppress generation of a curl in the area including the center portion of the sheet as compared to the configuration in which the stop time is set based only on the adherence amount information at the end portions of the image forming area R10.

It is noted that the image forming apparatus 100 may include an image reading portion which reads an image formed on a front surface of a sheet conveyed by the sheet conveying portion 2. In this case, the acquisition processing portion 61 may acquire the adherence amount information for each of the specific areas R20 based on a result of the reading by the image reading portion.

The present disclosure may also be applied to an image forming apparatus including two head portions 21 (a head portion 21 used for image formation on a front surface of a sheet and a head portion 21 used for image formation on a back surface of the sheet).

### [Notes of Disclosure]

Hereinafter, a general outline of the disclosure extracted from the embodiment described above will be noted. It is noted that the respective configurations and processing functions described in the notes below can be sorted and arbitrarily combined as appropriate.

### <Note 1>

An image forming apparatus, including: an ejection portion which ejects ink toward a conveyed sheet; an acquisition processing portion which acquires, when duplex image forming processing for forming images on a first surface and second surface of the sheet using the ejection portion is executed, adherence amount information related to an adherence amount of the ink by the image formation for each of a plurality of specific areas preset in an image forming area on the first surface of the sheet; a setting processing portion which sets a stop time during which conveyance of the sheet is stopped, based on a plurality of pieces of the adherence amount information acquired by the acquisition processing portion; and a stop processing portion which temporarily stops, based on the stop time set by the setting processing portion, the conveyance of the sheet after the image formation on the first surface of the sheet and before the image formation on the second surface of the sheet during the execution of the duplex image forming processing, in which the plurality of specific areas include a center portion area that is set at a center portion of the image forming area and an end portion area that is set at an end portion of the image forming area.

### <Note 2>

The image forming apparatus according to note 1, in which the adherence amount information is information indicating a coverage rate in each of the specific areas, and the setting processing portion corrects each piece of the adherence amount information using a correction coefficient preset for each of the specific areas, and sets, as the stop time, a time that is acquired based on a maximum value out of the corrected adherence amount information.

### <Note 3>

The image forming apparatus according to note 2, in which the end portion area includes a first area that is set at each corner portion of the image forming area on an upstream side of a conveying direction of the sheet and a second area that is set at each corner portion of the image forming area on a downstream side of the conveying direction, the correction coefficient set for the first area is largest out of a plurality of the correction coefficients respectively corresponding to the plurality of specific areas, and the correction coefficient set for the second area is second largest out of the plurality of correction coefficients respectively corresponding to the plurality of specific areas.

### <Note 4>

The image forming apparatus according to any one of notes 1 to 3, in which the setting processing portion sets the stop time based on a combination of the plurality of pieces of adherence amount information acquired by the acquisition processing portion, a type of the sheet, and a basis weight of the sheet.

### <Note 5>

An image forming method executed in an image forming apparatus including an ejection portion which ejects ink toward a conveyed sheet, including: an acquisition step of acquiring, when duplex image forming processing for forming images on a first surface and second surface of the sheet using the ejection portion is executed, adherence amount information related to an adherence amount of the ink by the image formation for each of a plurality of specific areas preset in an image forming area on the first surface of the sheet; a setting step of setting a stop time during which conveyance of the sheet is stopped, based on a plurality of pieces of the adherence amount information acquired in the acquisition step; and a stop step of temporarily stopping, based on the stop time set in the setting step, the conveyance of the sheet after the image formation on the first surface of the sheet and before the image formation on the second surface of the sheet during the execution of the duplex image forming processing, in which the plurality of specific areas include a center portion area that is set at a center portion of the image forming area and an end portion area that is set at an end portion of the image forming area.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus, comprising:
an ejection portion which ejects ink toward a conveyed sheet;
an acquisition processing portion which acquires, when duplex image forming processing for forming images on a first surface and second surface of the sheet using the ejection portion is executed, adherence amount information related to an adherence amount of the ink by the image formation for each of a plurality of specific areas preset in an image forming area on the first surface of the sheet;
a setting processing portion which sets a stop time during which conveyance of the sheet is stopped, based on a plurality of pieces of the adherence amount information acquired by the acquisition processing portion; and
a stop processing portion which temporarily stops, based on the stop time set by the setting processing portion, the conveyance of the sheet after the image formation on the first surface of the sheet and before the image formation on the second surface of the sheet during the execution of the duplex image forming processing, wherein
the plurality of specific areas include a center portion area that is set at a center portion of the image forming area and an end portion area that is set at an end portion of the image forming area.

2. The image forming apparatus according to claim 1, wherein
the adherence amount information is information indicating a coverage rate in each of the specific areas, and
the setting processing portion corrects each piece of the adherence amount information using a correction coefficient preset for each of the specific areas, and sets, as the stop time, a time that is acquired based on a maximum value out of the corrected adherence amount information.

3. The image forming apparatus according to claim 2, wherein
the end portion area includes a first area that is set at each corner portion of the image forming area on an upstream side of a conveying direction of the sheet and a second area that is set at each corner portion of the image forming area on a downstream side of the conveying direction,
the correction coefficient set for the first area is largest out of a plurality of the correction coefficients respectively corresponding to the plurality of specific areas, and
the correction coefficient set for the second area is second largest out of the plurality of correction coefficients respectively corresponding to the plurality of specific areas.

4. The image forming apparatus according to claim 1, wherein
the setting processing portion sets the stop time based on a combination of the plurality of pieces of adherence amount information acquired by the acquisition processing portion, a type of the sheet, and a basis weight of the sheet.

5. An image forming method executed in an image forming apparatus including an ejection portion which ejects ink toward a conveyed sheet, comprising:
an acquisition step of acquiring, when duplex image forming processing for forming images on a first surface and second surface of the sheet using the ejection portion is executed, adherence amount information related to an adherence amount of the ink by the image formation for each of a plurality of specific areas preset in an image forming area on the first surface of the sheet;
a setting step of setting a stop time during which conveyance of the sheet is stopped, based on a plurality of pieces of the adherence amount information acquired in the acquisition step; and
a stop step of temporarily stopping, based on the stop time set in the setting step, the conveyance of the sheet after the image formation on the first surface of the sheet and before the image formation on the second surface of the sheet during the execution of the duplex image forming processing, wherein
the plurality of specific areas include a center portion area that is set at a center portion of the image forming area and an end portion area that is set at an end portion of the image forming area.
